(19) United States
(12) Patent Application Publication
(10) Pub. No.: US 2025/0356132 A1
(43) Pub. Date: Nov. 20, 2025

(54) DEVICES AND METHODS FOR SEMANTIC COMMUNICATIONS

(71) Applicant: Huawei Technologies Co., Ltd., Shenzhen (CN)

(72) Inventors: Abdellatif Zaidi, Boulogne Billancourt (FR); Piotr Krasnowski, Boulogne Billancourt (FR)

(21) Appl. No.: 19/264,201

(22) Filed: Jul. 9, 2025

Related U.S. Application Data
(63) Continuation of application No. PCT/EP2023/050407, filed on Jan. 10, 2023.

(51) Int. Cl. G06F 40/30; G06F 9/50

(52) U.S. Cl. CPC G06F 40/30; G06F 9/5066

(57) ABSTRACT

This disclosure relates to semantic communications. A parent device determines one or more sub-goals based on a goal. The parent device assigns the sub-goals to one or more child devices. Each child device obtains an input, performs semantic extraction on the input to obtain intermediate features, and performs semantic processing on the intermediate features to validate the assigned sub-goal. If the sub-goal is validated, the child device sends a decision flag to its parent device. If the sub-goal cannot be validated, the child device compresses the input by using a neural network, and provide an activation vector output by the neural network to the parent device. The parent device, if receiving a decision flag, may directly validate its own goal based on the decision flag. If receiving an activation vector, the parent device performs semantic extraction and semantic processing on the activation vector to validate its own goal.

### CROSS-REFERENCE TO RELATED APPLICATIONS

This application is a continuation of International Application No. PCT/EP2023/050407, filed on Jan. 10, 2023, the disclosure of which is hereby incorporated by reference in its entirety.

### TECHNICAL FIELD

The present disclosure relates generally to the field of communications technology. For instance, the disclosure relates to devices and methods for semantic communications.

### BACKGROUND

An increasing number of applications and services (such as robotics, autonomous driving, traffic management, and smart factory) rely on artificial intelligence (AI) techniques such as object recognition and computer vision. In these applications and services, multiple distributed sensors gather information about the environment in order to enable some complex decision-making at a control center. However, due to the growing amount and/or complexity of sensor data to be transmitted by the sensors and processed by the control center, efficient decision-making becomes a very challenging task.

For processing distributed data acquired by the multiple distributed sensors, distributed machine learning models, such as neural networks (NNs), may be used. These distributed models need proper training, which may be referred to as a learning phase or a training phase. In many situations, learning needs to be performed in a distributed manner. For instance, when parts of relevant data are obtained or measured at multiple distributed local sites. Sometimes, the data/measurements cannot be transmitted directly to a remote central center due to limited bandwidth and/or privacy concerns. Thus, parts of possibly correlated data need to be processed locally by each agent/node deployed at each local site during both training and inference phases. The processed, compressed measurements can be then transmitted over the network to the remote central center.

One possible and efficient solution for training distributed machine learning models is “In-Network Learning” (INL), which is disclosed in “In-Network Learning: Distributed Training and Inference in Networks”, M. Moldoveanu and A. Zaidi, 2021. The INL provides a new distributed learning and inference architecture in which an arbitrary number of agents/nodes are involved during both training phase and the inference phase. All agents/nodes that are involved during the training phase are also active during the inference phase. The nodes operate simultaneously, not sequentially. Specifically, during the training phase, every node uses its own NN to perform a forward pass on its data, possibly using also all received information from previous agents/nodes in the network as part of the NN. If the node does not have data, it only uses the incoming information as input of its NN. If the node has no parents in the network, it only uses its available data as input. If it has no available data, it only uses the incoming information as input of its NN. In these cases, the available/acquired information is concatenated vertically in a vector of inputs prior to using it as input of the node's NN.

Then, the agent/node sends the vector output of the last layer (called activation vector) of its NN to the next nodes to which it is connected in the graph network. The propagation of the forward pass continues until it reaches the end agent/node at which the decision needs to be made. This node continues the forward pass. It then computes a backward pass on its local NN. The output of the first layer of its NN during the backward step is firstly split vertically and then sent back to the parents' agents/nodes. Each of those first computes the sum of all vectors it receives and then continues the backward pass. The process continues until convergence.

In an application scenario of distributed semantic communications, multiple edge devices (or nodes), possibly some intermediate nodes (e.g., base stations), and a fusion center (FC) may be involved. The edge nodes comprise sensors adapted to observe environment and collect possibly raw data. The raw data may be multi-modal (e.g., videos, audio, etc.). Thus, the edge nodes may also be referred to as sensing devices. Bi-directional communication between the nodes is allowed. However, due to communication/privacy constraints, it is not possible or not allowed for the sensing nodes to share raw data with the FC. The FC is adapted to solve a complex objective (or referred to as a global goal). The global goal may be expressible using some suitable compositional language (e.g., logic-based language or graph-based language). Examples of such a global goal could be detecting events posing a security risk to pedestrians, determining the root cause of a road accident, counting specific objects present in an observed scene, and so on. Each element for semantic communication may comprise machine learning models (e.g., neural networks) that need to be trained and then performs inferencing, respectively, for semantic networking.

### SUMMARY

For distributed semantic training and/or inferencing, the FC facing a global goal not only needs to correctly interpret observed data, but also has to perform semantic reasoning using logical rules and some context/background knowledge (BK). Therefore, solving the global goal goes beyond simple tasks such as solving conventional classification/regression tasks and scene graph generation.

Therefore, it is crucial to find a suitable signaling, encoding, and decoding mechanism that allows the FC to efficiently solve its global goal, preferably without direct access to raw data collected by the sensors.

There are several challenges. Firstly, the edge devices and any intermediate nodes, which observe only partial data, are only able to properly extract partial semantic information from raw data that is semantically meaningful for the global goal of the FC. Further, the extracted semantic information needs to be properly processed using context/background knowledge. However, each node may only have access to incomplete context/background knowledge. Further, some semantic facts of the global goal could be derived only by considering jointly data from multiple sensors, which means that in this case, no edge device alone is able to solve the global goal. These lead to typical issues with object misdetection or duplication that occur when each edge device observes only a portion of the whole environment.

In some conventional distributed inferencing/training methods, an edge device may send activation values output by its machine learning model. However, these activation values are still relatively large in size and still incur relatively high communication costs. Thus, scarce communication resources may be wasted and unnecessary delays may be introduced.

In view of the aforementioned disadvantages and problems, the present disclosure aims at providing a solution for distributed semantic processing and communication. A further objective may be to improve performance (e.g., lower latency, robustness, flexibility, and energy consumption) of the learning/inferencing for performing distributed semantic processing and communication. These and other objectives are achieved by this disclosure, for instance, as described in the independent claims. Advantageous implementations are further described in the dependent claims.

A first aspect of the present disclosure provides a parent device. The parent device is configured to:
obtain a goal, wherein the goal comprises one or more computation tasks;
determine one or more sub-goals based on the goal, wherein each sub-goal is at least a subset of the goal;
send the one or more sub-goals to one or more child devices;
responsive to receiving, from a respective child device, a decision of a respective sub-goal, perform semantic processing on the respective decision to validate the goal; and
responsive to not receiving, from the respective child device, the decision of the respective sub-goal, obtain processed data from the respective child device, perform semantic extraction on the processed data to obtain one or more intermediate features of the processed data, and perform semantic processing on the one or more intermediate features to validate the goal.

Optionally, for performing semantic processing, when only one intermediate feature is received, the parent device may be configured to validate the goal directly based on the corresponding intermediate feature. When two or more intermediate features are received, the parent device may be configured to combine the two or more corresponding intermediate features, and validate the goal based on the combination. Optionally, the two or more corresponding intermediate features may be combined using logical operation(s) (such as “AND”, “OR” and the like). Optionally, the goal may be validated using background knowledge of the parent device.

Optionally, a respective intermediate feature may be used to represent a property associated with an object or an event related to the goal.

Optionally, the processed data may be an activation vector (or referred to as activation values). The activation vector may be an output of the last layer of a neural network of a corresponding child device.

By processing the input data at a semantic level, the child device is capable of sending only relevant or useful information with respect to its sub-goal(s). Thus, the data rate can be significantly reduced. Moreover, improved performance, such as lower latency, stronger robustness, flexibility, and reduced energy consumption, can also be achieved.

In an implementation form of the first aspect, the decision may comprise an indication bit indicating the sub-goal is validated on the respective child device.

Optionally, the indication bit may be a one-bit value or simply a flag. The indication bit may be used by the child device to inform the parent device that the sub-goal is successfully validated. That is, the corresponding computation task is positively finished on the respective child device.

In this way, the communication overhead can be significantly reduced by transmitting only one bit instead of the raw data.

In a further implementation form of the first aspect, the decision may further comprise a confidence of the decision.

Optionally, the confidence may be a numerical value, such as a percentage value. Alternatively, the confidence may be indicated by various levels, such as high, middle, low confidence levels. These various levels may be indicated by different values, such as bit values.

In this way, when the parent device receives a plurality of decisions from a plurality of child devices, the parent device may be adapted to take the confidence of each decision into consideration when combining the plurality of decisions by semantic processing. For instance, corresponding weights may be assigned to each decision according to their confidence.

In a further implementation form of the first aspect, the decision may further comprise one or more extracted features.

Optionally, an extracted feature may be an intermediate feature extracted through semantic extraction. Alternatively or additionally, the decision may comprise extra information such as a geographical location of a respective child device, and/or a time stamp. For instance, the time stamp may be used to indicate a time point when the input data is captured by the child device or when the decision is made.

By providing the one or more extracted features, the extra information, and/or the portion of the processed data in addition, the parent device may use the additional useful information to validate the goal. In this way, the precision of the validation of the goal can be improved.

In a further implementation form of the first aspect, for performing semantic extraction on the processed data, the parent device may be configured to detect one or more objects. Optionally, the parent device may be further configured to detect one or more attributes of a detected object from the processed data.

Optionally, the one or more objects, and the optional attributes associated therewith, may be represented using a scene graph. However, it is noted that the scene graph is optional and not necessary, which may be optionally generated depending on application scenarios.

In this way, the precision of the validation of the goal can be further improved.

In a further implementation form of the first aspect, the parent device may comprise a first neural network model (or simply, neural network (NN)) adapted to perform semantic extraction.

In a further implementation form of the first aspect, for performing semantic processing, the parent device may be configured to validate semantic facts that are related to the goal.

Optionally, the semantic facts may be determined by the parent device according to the one or more intermediate features obtained by semantic extraction.

In a further implementation form of the first aspect, in response to receiving a plurality of decisions from a plurality of child devices, the parent device may be configured to combine the plurality of decisions and perform semantic processing on the combined decisions.

Optionally, two or more of the plurality of child devices may be assigned with a same sub-goal. In this way, by combining the plurality of decisions from two or more child devices, the precision of the validation of the goal can be further improved due to the wisdom of crowds. Alternatively, the two or more of the plurality of child devices may be assigned with different sub-goals. In this way, the precision of the validation of the goal can also be further improved due to inputs from various perspectives.

In a further implementation form of the first aspect, in response to obtaining two or more pieces of processed data from two or more child devices, the parent device may be configured to concatenate, sum, or stitch the two or more pieces of processed data.

Optionally, the concatenation, summation or stitching may be performed before semantic extraction to obtain concatenated, summed, or stitched processed data. The parent device may be configured to perform semantic extraction based on the concatenated, summed, or stitched processed data.

In this way, the precision of the validation of the goal can be further improved by combining different processed data from different child devices.

In a further implementation form of the first aspect, in response to determining that the goal is not validated, the parent device may be further configured to:
determine the one or more updated sub-goals based on the goal; and
send the one or more updated sub-goals to the one or more child devices.

In this way, the one or more sub-goals may be dynamically updated according to the performance of the validation result of the goal. Thus, the overall performance of semantic communication can be improved.

In a further implementation form of the first aspect, the parent device may be configured to communicate with the one or more child devices in one or more pre-determined time slots.

Optionally, the parent device may be configured to communicate with the one or more child devices in a synchronized manner.

In this way, synchronization among all the devices can be achieved, and communication efficiency can be improved.

In a further implementation form of the first aspect, the parent device may be further configured to select the one or more child devices based on side information. The side information may comprise one or more of the following information:
usefulness of input data obtained by each child device;
processing capability of each child device;
learned knowledge of each child device; and
learned knowledge of the parent device.

In this way, the assignment of sub-goals may be more targeted based on the side information. Thus, the communication efficiency can be improved since each device can be assigned one or more proper sub-goals.

A second aspect of the present disclosure provides a child device. The child device is configured to:
obtain a sub-goal from a parent device, wherein the sub-goal is at least a subset of a goal of the parent device, wherein the goal comprises one or more computation tasks;
obtain input data and perform semantic extraction on the input data to obtain one or more intermediate features of the input data;
perform semantic processing on the one or more intermediate features to validate the sub-goal;
responsive to determining that the sub-goal is validated, send a decision of the sub-goal to the parent device; and
responsive to determining that the sub-goal is not validated, compress the input data to obtain processed data, and send the processed data to the parent device.

Optionally, the child device may be configured to receive two or more sub-goals from the parent device.

Optionally, for performing semantic processing, when only one intermediate feature is received, the child device may be configured to validate the sub-goal directly based on the corresponding intermediate feature. When two or more intermediate features are received, the child device may be configured to combine the two or more corresponding intermediate features, and validate the sub-goal based on the combination. Optionally, the two or more corresponding intermediate features may be combined using logical operation(s) (such as “AND”, “OR” and the like). Optionally, the sub-goal may be validated using background knowledge of the child device.

Optionally, a respective intermediate feature may be used to represent a property associated with an object or an event related to the sub-goal.

By processing the input data at a semantic level, the child device is capable of sending only relevant or useful information with respect to its sub-goal(s). Thus, the data rate can be significantly reduced. Moreover, improved performance, such as lower latency, stronger robustness, flexibility, and reduced energy consumption, can also be achieved.

In an implementation form of the second aspect, the decision may comprise an indication bit indicating the sub-goal is validated.

Optionally, the indication bit may be a one-bit value or simply a flag. The indication bit may be used by the child device to inform the parent device that the sub-goal is successfully validated. That is, the corresponding computation task is positively finished on the respective child device.

In this way, the communication overhead can be significantly reduced by transmitting only one bit instead of the raw data.

In a further implementation form of the second aspect, the decision may further comprise a confidence of the decision.

Optionally, the confidence may be a numerical value, such as a percentage value. Alternatively, the confidence may be indicated by various levels, such as high, middle, low confidence levels. These various levels may be indicated by different values, such as bit values.

Optionally, the decision may further comprise one or more extracted features. An extracted feature may be an intermediate feature extracted through semantic extraction. Alternatively or additionally, the decision may comprise extra information such as a geographical location of the child device, and/or a time stamp. For instance, the time stamp may be used to indicate a time point when the input data is captured by the child device or when the decision is made.

In a further implementation form of the second aspect, for performing semantic extraction on the input data, the child device may be configured to detect one or more objects. Optionally, the child device may be further configured to detect one or more attributes of a detected object from the input data.

In a further implementation form of the second aspect, the child device may comprise a second neural network model adapted to perform semantic extraction.

In a further implementation form of the second aspect, for performing semantic processing, the child device may be configured to validate semantic facts that are related to the sub-goal.

Optionally, the semantic facts may be determined by the child device according to one or more intermediate features obtained by semantic extraction.

In a further implementation form of the second aspect, for compressing the input data, the child device may comprise a third neural network model adapted to infer the input data, to obtain a feature map of the input data as the compressed data.

Optionally, the feature map of the input data may be an activation vector (or referred to as activation values). The activation vector may be an output of the last layer of the third neural network.

In a further implementation form of the second aspect, the child device may be configured to communicate with the parent device in one or more pre-determined time slots.

A third aspect of the present disclosure provides a system comprising one or more parent devices according to the first aspect or any implementation form thereof, and one or more child devices according to the second aspect or any implementation form thereof.

A fourth aspect of the present disclosure provides a method comprising the following steps:
obtaining, by a parent device, a goal, wherein the goal comprises one or more computation tasks;
determining, by the parent device, one or more sub-goals based on the goal, wherein each sub-goal is at least a subset of the goal;
sending, by the parent device, the one or more sub-goals to one or more child devices;
responsive to receiving, from a respective child device, a decision of a respective sub-goal, performing, by the parent device, semantic processing on the decision to validate the goal; and
responsive to not receiving, from the respective child device, the decision of the sub-goal, obtaining, by the parent device, processed data from the respective child device, performing semantic extraction on the processed data to obtain one or more intermediate features of the processed data, and performing semantic processing on the one or more intermediate features to validate the goal.

In an implementation form of the fourth aspect, the decision may comprise an indication bit indicating the sub-goal is validated on the respective child device.

In a further implementation form of the fourth aspect, the decision may further comprise a confidence of the decision.

In a further implementation form of the fourth aspect, the decision may further comprise one or more extracted features.

In a further implementation form of the fourth aspect, the step of performing semantic extraction on the processed data may comprise detecting, by the parent device, one or more objects. Optionally, one or more attributes of a detected object may be detected by the parent device from the processed data.

In a further implementation form of the fourth aspect, the parent device may comprise a first neural network model adapted to perform semantic extraction.

In a further implementation form of the fourth aspect, the step of performing semantic processing may comprise validating, by the parent device, semantic facts that are related to the goal.

In a further implementation form of the fourth aspect, in response to receiving a plurality of decisions from a plurality of child devices, the method may comprise combining, by the parent device, the plurality of decisions; and performing, by the parent device, semantic processing on the combined decisions.

In a further implementation form of the fourth aspect, in response to obtaining two or more pieces of processed data from two or more child devices, the step of performing semantic processing on the one or more intermediate features may comprise concatenating, summing, or stitching, by the parent device, the two or more pieces of processed data.

In a further implementation form of the fourth aspect, in response to determining that the goal is not validated, the method may further comprise the following steps:
determining, by the parent device, the one or more updated sub-goals based on the goal; and
sending, by the parent device, the one or more updated sub-goals to the one or more child devices.

In a further implementation form of the fourth aspect, the method may comprise communicating, by the parent device, with the one or more child devices in one or more pre-determined time slots.

In a further implementation form of the fourth aspect, the method may comprise selecting, by the parent device, the one or more child devices based on side information. The side information may comprise one or more of the following information:
usefulness of input data obtained by each child device;
processing capability of each child device;
learned knowledge of each child device; and
learned knowledge of the parent device.

The method of the fourth aspect may share the same optional features and have the same technical advantages and benefits as the parent device according to the first aspect accordingly.

A fifth aspect of the present disclosure provides a method comprising the following steps:
obtaining, by a child device, a sub-goal from a parent device, wherein the sub-goal is at least a subset of a goal of the parent device, wherein the goal comprises one or more computation tasks;
obtaining, by the child device, input data, and performing semantic extraction on the input data to obtain one or more intermediate features of the input data;
performing, by the child device, semantic processing on the one or more intermediate features to validate the sub-goal;
responsive to determining that the sub-goal is validated, sending, by the child device, a decision of the sub-goal to the parent device; and
responsive to determining that the sub-goal is not validated, compressing, by the child device, the input data to obtain processed data, and sending the processed data to the parent device.

In an implementation form of the fifth aspect, the decision may comprise an indication bit indicating the sub-goal is validated.

In a further implementation form of the fifth aspect, the decision may further comprise a confidence of the decision.

In a further implementation form of the fifth aspect, the step of performing semantic extraction on the input data may comprise detecting, by the child device, one or more objects. Optionally, one or more attributes of a detected object may be detected by the child device from the input data.

In a further implementation form of the fifth aspect, the child device may comprise a second neural network model adapted to perform semantic extraction.

In a further implementation form of the fifth aspect, the step of performing semantic processing may comprise validating, by the child device, semantic facts that are related to the sub-goal.

In a further implementation form of the fifth aspect, for compressing the input data, the child device may comprise a third neural network model adapted to infer the input data, to obtain a feature map of the input data as the compressed data.

In a further implementation form of the fifth aspect, the method may comprise communicating, by the child device, with the parent device in one or more pre-determined time slots.

The method of the fifth aspect may share the same optional features and have the same technical advantages and benefits as the child device according to the second aspect accordingly.

A sixth aspect of the present disclosure provides a computer program comprising a program code for performing the method according to the fourth aspect or any of its implementation forms, or according to the fifth aspect or any of its implementation forms.

A seventh aspect of the present disclosure provides a non-transitory storage medium storing executable program code which, when executed by a processor, causes the method according to the fourth aspect or any of its implementation forms, or according to the fifth aspect or any of its implementation forms to be performed.

An eighth aspect of the present disclosure provides a chipset comprising a memory and a processor, which are configured to store and execute program code to perform the method according to the fourth aspect or any of its implementation forms, or according to the fifth aspect or any of its implementation forms.

It has to be noted that all devices, elements, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following disclosure, a specific functionality or step to be performed by external entities is not reflected in the description of a specific detailed element of that entity, which performs that specific step or functionality, it should be clear for a skilled person that these methods and functionalities can be implemented in respective software or hardware elements, or any kind of combination thereof.

### BRIEF DESCRIPTION OF THE DRAWINGS

The above-described aspects and implementation forms will be explained in the following description of specific embodiments in relation to the enclosed drawings, in which

FIG. 1 shows a parent device and a child device according to this disclosure;

FIG. 2 shows an example of goal translation according to this disclosure;

FIG. 3 shows a system according to the present disclosure;

FIG. 4 shows an application scenario according to this disclosure;

FIG. 5 shows an example of detecting a car imposing security risks and corresponding signaling between nodes;

FIG. 6 shows a synchronization mechanism according to this disclosure;

FIG. 7 shows a distributed joint training of neural networks according to this disclosure;

FIG. 8 shows a method for building a set of potential goals that each node is able to solve according to this disclosure;

FIG. 9 shows a method according to this disclosure;

FIG. 10 shows a further method 1000 according to this disclosure; and

FIG. 11 shows an effect of intermittent communication according to this disclosure.

### DETAILED DESCRIPTION OF ILLUSTRATIVE EMBODIMENTS

This disclosure provides a solution for distributed semantic processing and communication. The solution offers massively reduced communication costs and enhanced privacy compared with a situation in which data collected by sensing nodes are directly sent to the fusion center. The solution also provides significantly improved performance (e.g., lower latency, robustness, flexibility, and energy consumption) compared with general-purpose distributed training/learning techniques, while enabling efficient data fusion from multiple sensors.

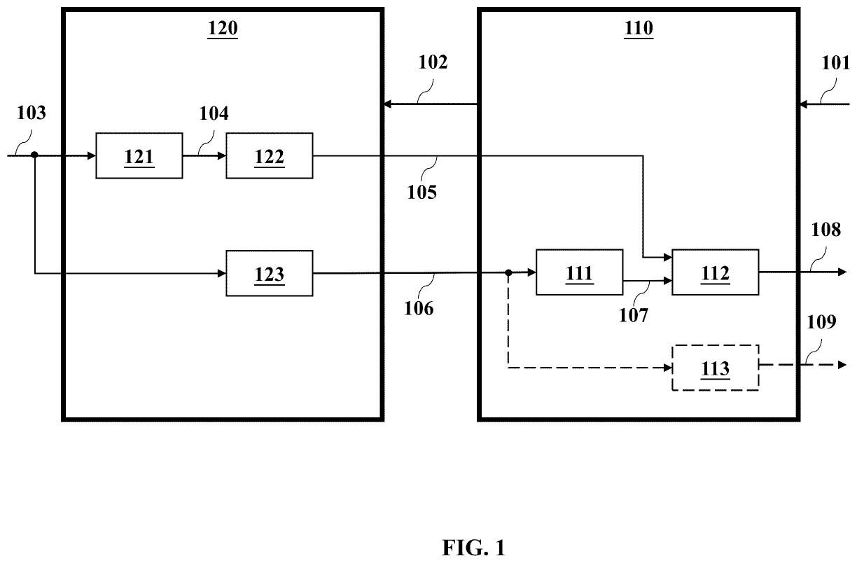

In the FIGS. 1 to 11, corresponding elements may share the same features and may function likewise.

FIG. 1 shows a parent device 110 and a child device 120 according to this disclosure. The parent device 110 and the child 120 are communication nodes in a semantic communications network. The child device 120 and the parent device 110 may be connected using a wired or wireless connection in the network. In this disclosure, terms of “device” and “node” may be used interchangeably.

The parent device 110 may comprise a semantic extraction (SE) component 111 adapted to perform semantic extraction, a semantic processing (SP) component 112 adapted to perform semantic processing. When the parent device is an intermediate node, the parent device may comprise a NN processing component (or referred to as the fourth NN) 113. When the parent device is an end server, such as an FC, the parent device does not comprise the NN processing component 113.

The child device 120 may comprise its own SE component 121 adapted to perform semantic extraction, an SP component 122 adapted to perform semantic processing, and a NN processing component (or referred to as the third NN) 123.

Optionally, the connection may be cascaded. That is, when the parent device 110 is an intermediate node, the parent device 110 may be connected with its own parent device (or referred to as “further parent device”, which is not shown in FIG. 1). In this case, the parent device 110, facing its own parent device, may be adapted to function as a child device similar to the child device 120. Therefore, in FIG. 1, elements 111, 112 and 113 may correspond to elements 121, 122 and 123, and thus, they may share the same features correspondingly where appropriate.

The parent device 110 is configured to obtain a goal 101. The goal 101 may be sent from a further device of a higher level (e.g., a further parent device of the parent device 110). The goal 101 comprises one or more computation tasks. Each computation task may be validated.

The parent device 110 is configured to determine one or more sub-goals based on the goal. Each sub-goal may be at least a subset of the goal 101. That is, each sub-goal may comprise at least one computation task of the one or more computation tasks comprised in the goal 101. The parent device 110 is configured to send the one or more sub-goals to one or more child devices. It is not necessary to have a one-to-one correspondence between the one or more sub-goals and the one or more child devices. That is, a child device may be configured to receive one or more sub-goals from the parent device. Two child devices may be configured to receive a same goal. For instance, a first child device may receive one sub-goal #1, a second child device may receive two sub-goals #2 and #3, a third child device may receive sub-goal #1. In FIG. 1, one child device 120 receiving a sub-goal 102 is illustrated for the sake of simplicity.

It is noted that each goal (or each sub-goal) of a respective device may be referred to as a local goal (or local sub-goal). For instance, the parent device 110 may have its local goal 101, and the child device 120 may have its local sub-goal 102.

For validating the received sub-goal 102, the child device 120 is configured to obtain input data 103 and perform semantic extraction on the input data 103 to obtain one or more intermediate features 104 of the input data 103. The child device 120 is further configured to perform semantic processing on the one or more intermediate features 104 to validate the sub-goal.

Optionally, each intermediate feature may be used to represent a property describing an object or an event. For instance, a notation of “car” may have intermediate features of “moving object”, “wheel”, “windscreen”, “plate”, “carrying human”, “various colors” etc. One or more of such semantic features may be combined during semantic processing in order to validate whether it is a car.

For performing semantic processing, when only one intermediate feature is received, the parent device may be configured to validate the goal directly based on the corresponding semantic feature. When two or more intermediate features are received, the parent device may be configured to combine the two or more corresponding semantic features, and validate the goal based on the combination.

When the sub-goal 102 is validated by the child device 120 (or can be validated with high confidence), the child device 120 is configured to send a decision 105 of the sub-goal 102 to the parent device 110. The decision 105 may comprise an indication bit (e.g., one-bit value) or a flag indicating the sub-goal is validated. The decision may further comprise a confidence of the result. The confidence may be a percentage value indicating a confidence level of the decision (or the result). Optionally, the decision may further comprise one or more extracted features of the input data. The decision may be comprised in a response that is sent by the child device 120 to the parent device 110.

For instance, consider a sub-goal is “there is a car”. The child device 120 may comprise a camera taking video/photo as an input. The optional SE component 121 may be adapted to perform semantic extraction on the video/photo, in order to detect the existence of any property associated with a car (i.e., to extract any semantic feature of a car). For instance, if only one semantic feature of “moving object” is extracted by the SE component 121 and provided to the SP component 122, the SP component 122 cannot validate whether it is a car, or at least cannot validate it is a car with high confidence. In this case, the video/photo is input to the NN processing component 123 and the one or more intermediate features 106 are provided to the parent device 110. If two semantic features of “windscreen” and “plate” are extracted, the SP component 122 can validate a car is detected, or at least can validate a car is detected with high confidence. In this case, a flag, such as a one-bit value of “1”, is signaled by the child device 120 to the parent device 110. If there is no intermediate feature extracted at all, or if there is no valid input for performing semantic extraction: the child device 120 may be adapted to send nothing, or send a synchronization signal, such as “SYN” that can be pre-defined using a certain bit pattern, to the parent device 110.

Optionally, each sub-goal may be associated with an identity (ID). The decision and each intermediate feature may be associated with the sub-goal ID and/or with the ID of the child device 120.

After receiving the decision 102 from the child device 120, the parent device 110 is configured to perform semantic processing on the decision to validate the goal 101.

When the sub-goal 102 is not validated by the child device 120 (or cannot be validated with high confidence), the child device 120 is configured to compress the input data 103 to obtain processed data 106, and send the processed data 106 to the parent device. The compression of the input data 103 may be seen as pre-processing the input data 103 that is captured locally by the child device 120. The third NN 123 may be adapted to extract a feature map of the input data 103 as the processed data 106. The feature map may be an activation vector (or activation values) of the last layer of the third NN 123. The processed data 106 may be comprised in a response that is sent by the child device 120 to the parent device 110.

Since the sub-goal 102 is not validated, the child device 120 is configured not to send any decision to the parent device 110. When the parent device 110 fails to receive a decision of the sub-goal 102 from the child device 120, the parent device 110 is configured to obtain processed data 106 from the child device 120. The parent device 110 is further configured to perform semantic extraction on the processed data 106 to obtain one or more intermediate features 107 of the processed data, and perform semantic processing on the one or more intermediate features 107 to validate the goal 101. This is similar to the child device 120 validating its sub-goal 102. For instance, if the goal is validated, a decision 108 of the goal 101 is output by the parent device 110. If the goal 110 is not validated, the processed data that is compressed by the child device 120 is further compressed by the parent device 110 to obtain a further processed data 109, which can be provided to the further parent device.

For performing semantic extraction on the processed data, the parent device 110 may be configured to detect one or more objects (or referred to as “symbolic facts”) from the processed data 106. Optionally, the parent device 110 may be configured to determine one or more attributes of a detected object. To this end, the parent device may comprise a NN (herein referred to as “the first NN”) adapted to perform semantic extraction. The first NN may be hosted in the SE component 111 of the parent device 110. Similarly, the second NN may be hosted in the SE component 121 of the child device 120.

For performing semantic processing on the decision, the parent device 110 may be configured to validate the decision. Optionally, when the parent device 110 receives more than one decision from more than one child device, the parent device 110 may be configured to combine the plurality of decisions, and perform semantic processing on the combined decisions.

Optionally and additionally, one or more further intermediate features may be provided by a further child device (not shown in FIG. 1). In this case, the one or more intermediate features and the one or more further intermediate features may be combined for performing semantic processing.

In case that the goal cannot be validated, the parent device may need to re-think about the goal assignment. To this end, the parent device 110 may update the sub-goal 102 by determining the one or more further (or updated) sub-goals based on the goal, and send the one or more update sub-goals to the one or more child devices. In the view of the child device 120 in FIG. 1, its sub-goal 102 is updated.

Optionally, the parent device 110 may be configured to communicate with the one or more child devices in one or more pre-determined time slots simultaneously.

Optionally, the parent device 110 may be further configured to select the one or more child devices based on side information. The side information may comprise one or more of:
usefulness of input data obtained by each child device;
processing capability of each child device;
learned knowledge of each child device; and
learned knowledge of the parent device.

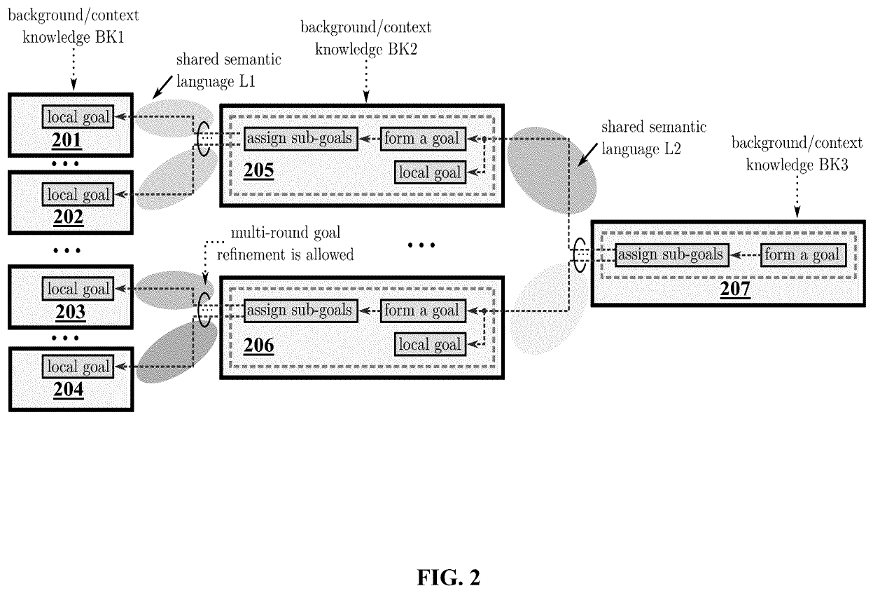

FIG. 2 shows an example of goal translation according to this disclosure. The task of goal translation is to translate a goal into one or more sub-goals. FIG. 2 shows a system which is built based on the child device 120 and the parent device 110 of FIG. 1. The system comprises an FC 207, two intermediate nodes 205, 206, and four edge nodes 201-204. When the FC 207 is seen as a parent device, the intermediate nodes 205, 206 can be seen as the child devices. When an intermediate node 205 is seen as a parent device, the respective two sensing nodes 201, 202 can be seen as the one or more child devices. In FIGS. 1 and 2, corresponding elements shall share similar features and function likewise.

The FC 207 may be adapted to obtain a global goal. This global goal may be formed according to an input instruction or may be given by an operator. For example, a human operator may input an instruction as a natural language query, and then the FC is adapted to parse the instruction into a formula in a suitable machine-oriented semantic language. Alternatively, the formula in a machine-oriented semantic language can be directly input in the FC 207. Then, the FC 207 is adapted to decompose the global goal into one or more sub-goals. Any suitable algorithm for decomposing global goals into sub-goals can be used. The one or more sub-goals are to be assigned to suitable child devices (or nodes) of the FC. The assigned one or more sub-goals on a child node can be seen as a local goal. The assignment of the sub-goals to the child nodes may take one or more of the following information into account:
usefulness of data that can be acquired by a child node;
processing capabilities of a child node (e.g., the ability to extract specific types of facts from its input data); and
available context/background knowledge of a child node (e.g., some domain-specific knowledge or implicitly learnt knowledge about the usefulness of a child node for solving a particular task).

For instance, as depicted in FIG. 2, the edge node 201 may have background knowledge BK1, while the intermediate node 205 may have background knowledge BK2.

The generated local goals are assigned by the FC 207 as a parent node to proper intermediate nodes 205, 206 as child nodes. These intermediate nodes 205, 206 have their own child nodes, e.g., the sensing nodes 201-204. The intermediate nodes 205, 206 may translate the obtained local goal further and assign new sub-goals to the sensing nodes 201-204 using the same method as described above. The method of sub-goal generation and assignment can be performed iteratively level by level until all nodes of the network have an assigned local goal.

It is noted that there is no strict one-to-one correspondence between the one or more local goals and the one or more child nodes. For instance, multiple child nodes may be assigned with an identical local goal. A child node may be assigned with a plurality of local sub-goals. A local sub-goal may be expressed in a semantic language that is understood by a child node. A local sub-goal may also comprise a plurality of further sub-goals that can be assigned to further child nodes (that is in the next level) by the child node. The assignment of goals (or sub-goals) may require that each pair of directly connected parent and child nodes agree on a common semantic language used for communication. Optionally, the parent device and its child device may mutually agree on a shared semantic language. For instance, as depicted in FIG. 2, the intermediate node 205 and the edge nodes 201, 202 agree on a first shared semantic language L1, while the FC 207 and the intermediates nodes 205, 206 agree on a second semantic language L2.

Optionally, a multi-round goal refinement may be allowed. For instance, if the sub-goal assigned by a parent device to a child device is not suitable for the child device, the parent device may be adapted to update the sub-goal and assigned the updated sub-goal to the child device. This process may be referred to as goal refinement and may be executed multiple rounds.

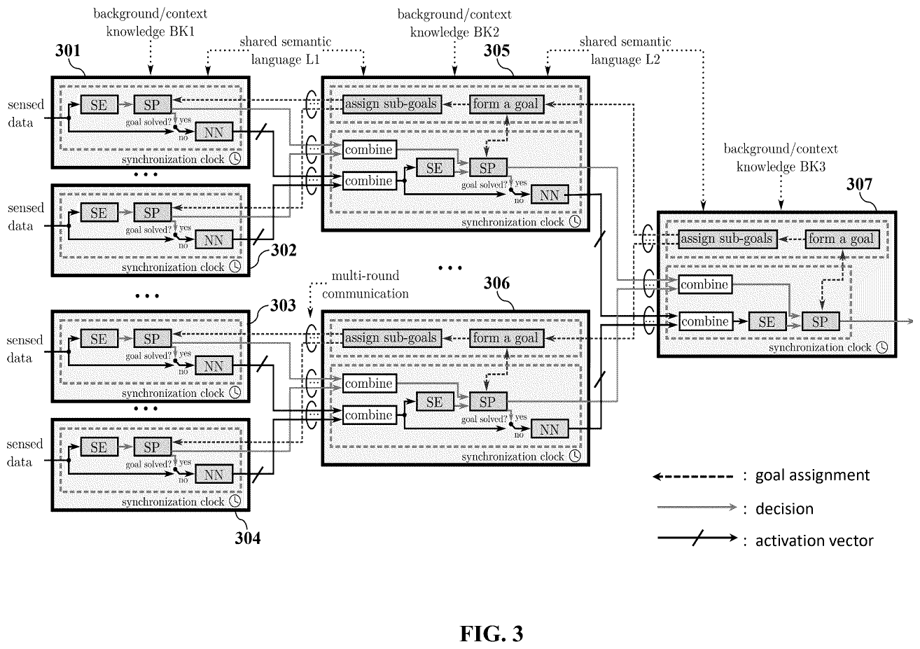

FIG. 3 shows a system according to the present disclosure.

Similar to FIG. 2, the system comprises an FC 307, several intermediate nodes 305, 306, and several edge nodes 301-304. The following introduced components may be comprised as functional/logical units in the nodes of the system.

A goal-forming component may be comprised at each intermediate node and the FC 307. The goal-forming component may be adapted to form a goal that represents or comprises one or more objectives that a respective node wants to validate (or invalidate). Each objective may contribute to solving a main goal, which is ultimately computed at the FC 307.

Optionally, each goal may be represented using formulas expressed using suitable compositional semantic languages. Each goal may comprise multiple sub-goals.

A goal-assignment component may be comprised at each intermediate node and the FC 307. The goal-assignment component may be adapted to translate a goal (or global goal) of a parent node into sub-goals (or local goals) to be assigned to each child node. This relationship may be recursive. For instance, each sub-goal may be further translated into further sub-goals. Sub-goals assigned to different child nodes can be expressed using different semantic languages. Multiple child nodes may be assigned with an identical sub-goal. One child may be assigned one or more sub-goals.

An NN (i.e., a third NN of a child device, or a fourth NN of a parent device) processing component may be comprised at each sensing and intermediate node. The NN processing component may be adapted to process input data (e.g., sensing data for sensing nodes or activation values for intermediate nodes), and output a compressed representation of the input data. The compressed representation may be activation values of lower dimensionality. In this disclosure, the NN processing component may also be referred to as an “NN-based compression component”.

A SE component may be comprised at each node. The SE component may be adapted to extract one or more intermediate features from the input data. For a parent node, the input data may be processed data from its one or more child devices. Optionally and additionally, the parent node may also comprise a sensing unit that is adapted to capture its own sensed data as input data in addition. As an example regarding functionality, the SE component may be configured to detect one or more objects from the input data. Optionally, the attributes and/or relations of the one or more objects may be determined by the SE component. The SE component may comprise a neural network (the first NN of the parent device, or the second NN of the child device) adapted to perform the aforementioned task(s). In general, the SE component may be adapted to perform any one or more of the following semantic tasks: classification task, object detection task, object recognition task, object relation recognition task, action recognition task, and scene graph generation task. Various existing machine learning algorithms (such as neural networks) commonly known in the field may be used for performing each of the above-mentioned tasks.

An SP component may be comprised at each node. The SP component may be adapted to process the one or more intermediate features extracted by the respective SE component to validate a (local) goal of a node (i.e., a goal of a parent device, or a sub-goal of a child device). The SP component may be adapted to use pre-encoded (or learned) context or background knowledge to better interpret the symbolic facts. The SP component may be adapted to perform logical operation(s) on the one or more intermediate features, and output a decision (if a local goal is validated). Optionally, the decision may be accompanied by confidence and/or extra information. The extra information may comprise one or more of: a geographical location of a respective node, and/or a time stamp. The timestamp may be used to indicate when the decision is made or when the input data is obtained.

After local goals are assigned to each node in the network according to FIG. 2, an inference phase begins. In the inference phase, each edge device may be adapted to collect input data. For instance, each edge device may comprise a sensor, or may be connected with a sensor. The sensor is adapted to collect input data, such as multi-modal data, and forward the input data to the respective edge device. At each edge device, the SE component is adapted to process the input data and output one or more semantic facts. The one or more semantic facts may be a semantic interpretation of the observed scene. The extracted one or more semantic facts are then provided to the respective SP component. Each SP component is adapted to validate the assigned local goal using semantic reasoning and local background knowledge.

If the local goal at the edge node can be validated, then the edge node is adapted to send a decision and possibly some related data or features to the parent node. If the local goal at the edge cannot be validated, the edge node is adapted to compress the input data and send the compressed data to the parent device.

Optionally, a confidence value may be used to define whether a local goal is validated. For instance, a confidence level of at least 70% may denote high confidence, while a confidence level below 70% may denote low confidence. It is noted that the value of confidence level 70% in this example is just given as an example, various thresholds may be used for different scenarios, such as 50% and 80%. For another example, the confidence level may be fine-tuned according to various needs, such as accuracy and sensitivity.

If the local goal at an edge node can be validated with high confidence, then the edge node is adapted to send a decision (e.g., a binary value or a flag) and possibly some related data/features to the parent node. As illustrated in FIG. 3, if the condition of “goal solved?” is yes, then a data path of the input sensed data is cut off. There is no valid input to the NN processing component, and thus, the NN processing component outputs nothing. If the local goal cannot be validated (e.g., the result of the SP component is with a relatively low confidence), the data path of the input sensed data is switched on. In this case, the edge node may be adapted to process its input data using its NN processing component. The NN processing component outputs a compressed version of the input data, for instance, an activation vector. These compressed data, possibly together with some related symbolic facts/data output by the SP component, are forwarded to the parent node. If the local goal cannot be validated, the edge node is adapted not to send any decision. Alternatively, the edge node may just send a synchronization flag. The synchronization flag may be used to inform the parent node that local processing has been done without a valid result at the child node, so that the parent node does not need to wait for a valid response from the child node.

The parent (e.g., intermediate) node is adapted to collect all data (or response) received from its child nodes and tries to solve its own local goal. When the parent node is the FC 307, then the FC 307 is adapted to solve the global goal. The response may comprise a decision or compressed data. The compressed data may be activation vectors.

The activation values from multiple nodes are combined (e.g., concatenated, summed, stitched, etc.) and processed by the SE component of the parent node. The extracted symbolic facts, together with the facts indicated by any received decision, are used by the SP component to validate the local goal. Depending on the result of the validation, the parent node may be adapted to proceed as described above for the child node and sends either a decision or compressed data (e.g., an activation vector). Optionally and additionally, the output of the SP component can be used to refine local goals assigned to the child nodes. If necessary, the parent node may be adapted to update the local goals and assign the updated local goals to the child nodes.

The processing and communication progress until it reaches the FC 307. The FC 307 is adapted to collect all data received from its direct child nodes, and tries to validate its global goal. Finally, the FC 307 is adapted to put a final result. Optionally, the FC 307 may be adapted to generate a new query (i.e., a new global goal), or send a termination signal as a consequence of validating the global goal, or ask for additional data, etc.

Optionally, validating a local goal at a parent node may require multiple rounds of communication (“multi-round communication”) between the parent and child nodes. It may be helpful, for example, when the parent node requires more evidence to validate its goal, or when the parent node decides to refine assigned local goals based on information already provided by child nodes.

Optionally, the semantic communication network may employ a suitable synchronization technique to maintain all the nodes in synchronization.

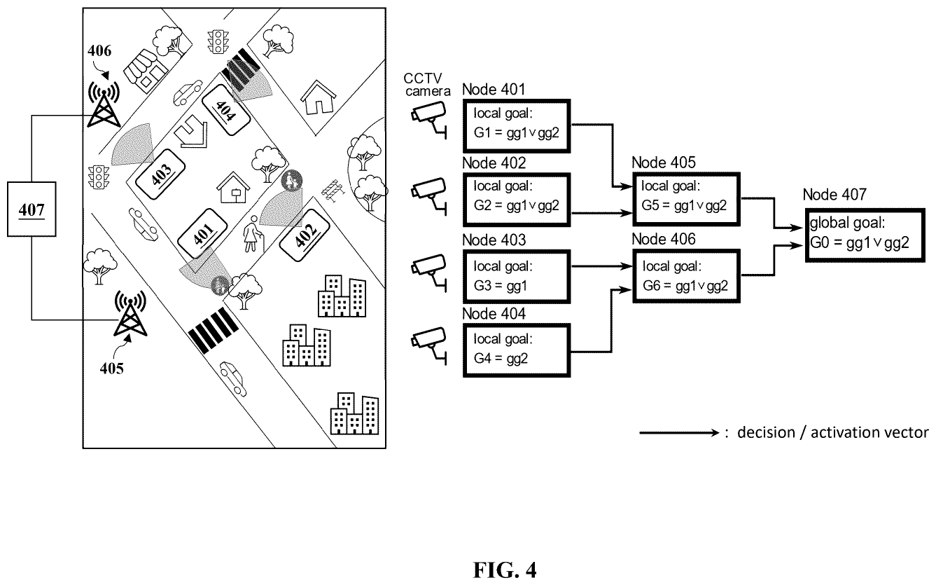

FIG. 4 shows an application scenario according to this disclosure. In the left-hand side of FIG. 4, a distributed network adapted to monitor safety in a suburban area is shown. The distributed network exemplarily comprises four sensing nodes (denoted as node 401-404), each with a camera; two base stations as intermediate nodes (denoted as node 405, 406); and a remote FC (denoted as node 407). The sensing nodes with cameras are adapted to monitor a respective sensing area. Sensing nodes 401 and 402 are connected (as child devices) with base station 405 (as a parent device). Sensing nodes 403 and 404 are connected (as child devices) with base station 406 (as a parent device). Base stations 405 and 406 are connected (as child devices) with FC 407 (as a parent device).

As an example, a simple global goal obtained or generated at the FC 407 may be denoted as Go=gg1 V gg2. Go denotes the global goal, gg1 and gg2 denote two computation tasks, and logic operator “V” denotes a logical disjunction as a logical “OR”. Each computation task may be a potential sub-goal. A sub-goal may also be a logical combination of multiple computation tasks, which leads to the sub-goal can be further divided into a plurality of further sub-goals. For instance, Go may denote a task of “detect a security risk”. gg1 may denote a sentence “there is a vehicle posing a security task”, gg2 may denote a sentence “there is a person holding a gun”. As another example not shown in FIG. 4, gg1 may be further divided into two further sub-goals: “there is a moving car” and “there are people walking in the path of a car”. These two further sub-goals may be connected using logical “AND”.

The right-hand side of FIG. 4 illustrates an example of goal assignment according to this disclosure. The FC 407 obtains the global goal Go and translates the goal into local goals for base stations 5 and 6. In this example, it is assumed that the FC 407 knows, based on its background knowledge and acquired context, that base stations 405 and 406 are capable of solving both sub-goals gg1 and gg2. Therefore, the assigned local goals G5 and G6 are identical to the global goal Go. Alternatively, if base station 405 is only capable of solving sub-goal gg1, the assigned local goal G5 may be gg1 only (not shown in FIG. 4).

The base stations 405, 406 as intermediate nodes receive their local goals and translate them further into sub-goals for the sensing nodes. In this example, similarly to the FC 407, node 405 assigns exactly the same local goals to nodes 401 and 402. On the other hand, node 406 assigns only gg1 to node 403 and only gg2 to node 404. The decision was made because node 406 is aware that node 403 does not know the concept “gun” (therefore, it is not capable of validating gg2) and that node 404 does not obtain useful input data for solving gg1 (for example, node 404 never observed any car in a pure pedestrian zone).

Consider the gg1 “there is a vehicle posing a security task” as an example. An output (i.e., the one or more intermediate features) of the SE component at a child node with a sensor (e.g., node 401) based on input data (e.g., captured video/photo) may be:
“the input data represents a car” with a confidence of 95%
“the car is red” with a confidence of 90%,
“the car moves fast (or above a certain speed)” with a confidence of 80%,
“the car is being driven by a person” with a confidence of 90%,
“the car is on a pedestrian area” with a confidence of 85%,
“the input data also represents a tree” with a confidence of 95%, etc.

The one or more intermediate features are then provided to the SP component for semantic processing (e.g., applying logical rules and semantic reasoning). For instance, the SP component may perform logical operations on the plurality of intermediate features, and validate the goal based on the one or more intermediate features using its background knowledge.

For instance, the SP component may consider and process the following intermediate features that are related to the goal gg1:
“the input data represents a car” with a confidence of 95% “AND”
“the car moves fast (or above a certain speed)” with a confidence of 80% “AND”
“the car is on a pedestrian area” with a confidence of 85%.

These three intermediate features are validated using the following background knowledge of the node 401:
background knowledge: “a car is a vehicle”; and
background knowledge: “fast movement in a pedestrian area poses risk to security”.

Then, the SP component outputs a decision flag. Optionally, a confidence value may be determined for the decision, e.g., 80% confidence.

It is noted that when the child node detects no car (e.g., a confidence whether the data represent a car is close to 0%), the child node may be configured to remain silent (e.g., send nothing). Alternatively, only a synchronization flag can be sent. That is, in this case, the child node is not configured to send a decision to its parent node. It is because the child node has no relevant information to send. However, if the local sub-goal is “detect there is no car in the pedestrian area”, then detecting no cars is a piece of useful information that should be communicated to the parent node.

Optionally, the decision may be accompanied with one or more extracted features and/or extra information. The one or more extracted features may include part of the one or more intermediate features derived by the SE component. The extra information may comprise one or more of: a geographical location of the node, and/or a time stamp indicating when the decision is made (or when the input is captured).

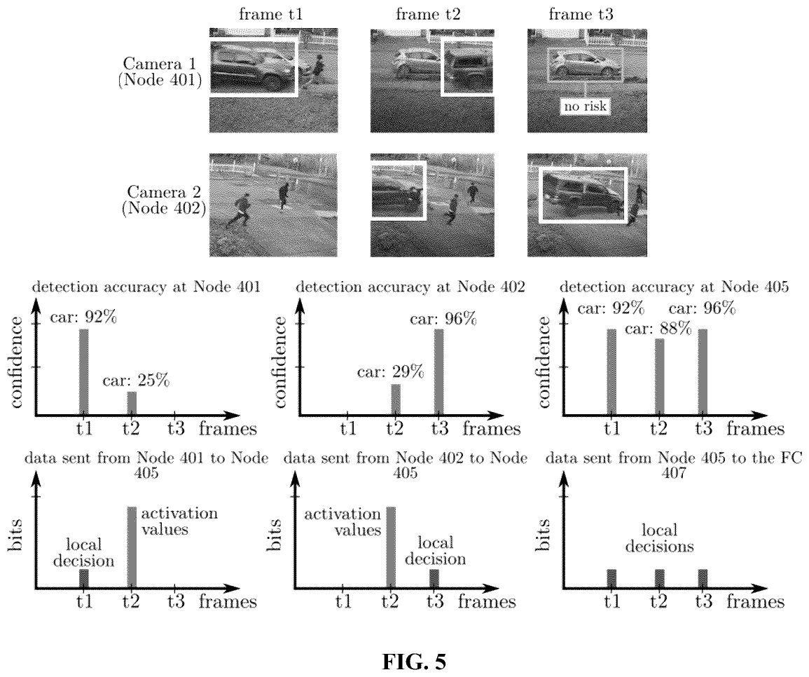

FIG. 5 shows an example of detecting a car imposing security risks and a corresponding signaling between nodes.

Based on the example in FIG. 4, cameras at nodes 401 and 402 may share partially overlapping areas. It is noted that the illustration of FIG. 5 is given with respect to the sub-goal gg1 introduced in FIG. 4. It is assumed that there is no valid input with respect to sub-goal gg2 in the examples of FIG. 5 (e.g., no gun is detected at all). FIG. 5 on the top side presents frames of videos (or photos) recorded by nodes 401 and 2 at three different frames (or time stamps) t1, t2, and t3. The frames illustrate a moving car which may pose a security risk to pedestrians. Communication between the devices is illustrated on the bottom side of FIG. 5.

At the time stamp t1, only node 401 detects (or observes) a car. Node 401, which is capable of solving sub-goal gg1, evaluates its collected data and decides with high confidence that the observed car poses risk to security in the pedestrian area. Therefore, it sends a decision flag to Node 405 to report the event. At the same time, node 402 does not observe any car and thus it remains silent (i.e., not sending any decision or processed data). Alternatively, node 402 may just send a synchronization flag (e.g., in each synchronized time slot).

It is noted that in some configurations, optionally, if a local goal can be validated as positive, a respective node may be adapted to send a decision or a flag (also referred to as a “decision flag”) indicating that the result of the computation task(s) of the local goal is positive. If the local goal can be validated as negative, the respective node may be adapted to remain silent, in order to save communication costs (such as node 401 at frame t3). When the respective node is not certain about whether the local goal can be validated or not, the respective node may compress its input data and send the compressed data to its parent node (such as node 401 at frame t2).

At the time stamp t2, the dangerous car moved forward and now it is partially observed by both nodes 1 and 2. Nodes 401 and 402 detect a car, but are unable to assess with high confidence whether the car poses risk to security. Therefore, instead of sending a decision flag, both nodes 401 and 402 compress respective images using their NN-based processing components and send activation vectors to their parent node: the intermediate node 405. The intermediate node 405 receives the activation values and processes them jointly. The joint evaluation of the input data can assist node 405 to determine the presence of an unauthorized car with a relatively high confidence. Therefore, Node 5 is able to send a decision to the FC 407. If in an alternative scenario when node 405 is not able to validate its local goal, Node 5 may be adapted to combine the data received from its child nodes 401 and 402, compressed the combined data through its own NN processing component, and send activation values to its parent node: the FC 407.

At the time stamp t3, the car imposing risk moved forward again and it is visible only by node 402. Node 402 then sends a decision to node 405, while node 401 remains silent. It can be noticed that node 401 observes another car, which is outside the pedestrian area and does not pose risk to pedestrians. Therefore, the presence of this safe car is not reported.

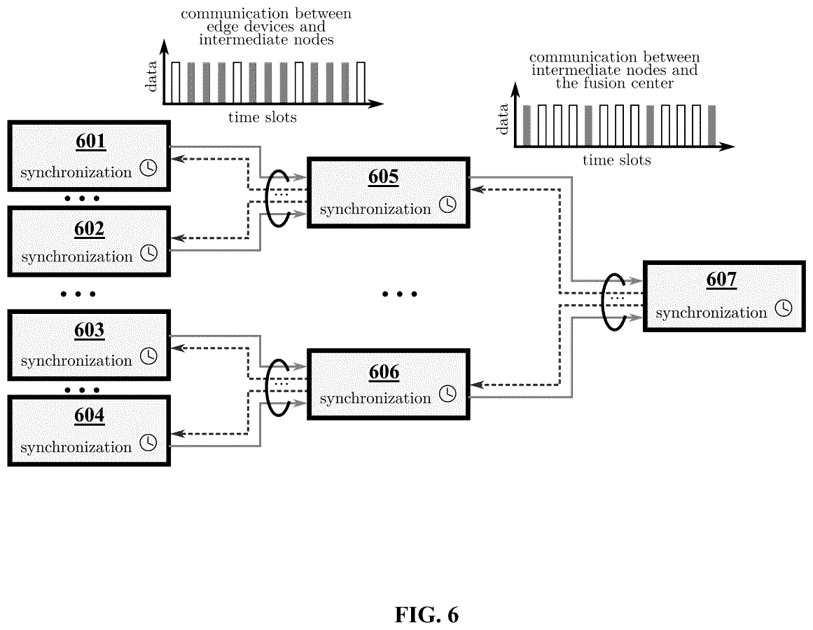

FIG. 6 shows a synchronization mechanism according to this disclosure. Similar to FIGS. 2-4, FIG. 6 shows a system comprising an FC 607, several intermediate nodes 605, 606, and several edge nodes 601-604.

Solving a global goal in a distributed manner in a network may sometimes require some degree of synchronization among all nodes in the network. The benefit of synchronization may be to avoid a situation in which devices report events occurring at different time stamps, and a corresponding parent has no knowledge of whether these events are related or isolated. This may potentially lead to erroneous interpretation at the parent node, and eventually at the FC. This issue can be aggravated by the fact that intermediate nodes may perform multiple rounds of communication with their child nodes, before reporting to the FC 607.

To address this issue, FIG. 6 shows a synchronization mechanism. Nodes of the same level are given pre-defined time slots for communication with their parent nodes. For instance, any node 601-604 may be adapted to use any one or more of the three allocated time slots for communication with its parent node. The slots can be assigned in such a manner that intermediate nodes can exchange data with edge nodes multiple rounds before sending their own decision to their parent nodes or the FC 607.

It is noted that the synchronization mechanism is not an essential but an optional feature in this disclosure.

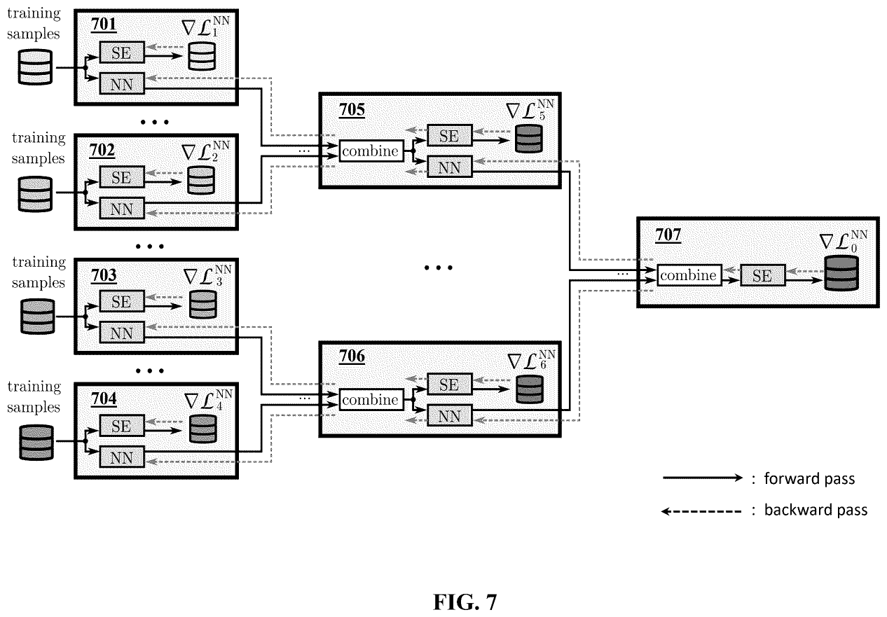

FIG. 7 shows a distributed joint training of neural networks according to this disclosure.

Similar to FIGS. 2, 3, 4, 6, FIG. 7 shows a system comprising a FC 707, several intermediate nodes 705, 706, and several edge nodes 701-704.

In this disclosure, all the neural networks (the first, second, third, and fourth NN) used at nodes for inferencing are trained and suitable for performing the respective tasks. For obtaining these trained neural networks, a distributed joint training method using a multi-task loss function is disclosed. This training method is based on conventional plain in-network learning. In this training method, a network topology and a training dataset are known. Different training datasets may be obtained according to various application scenarios. Moreover, each parent node is able to efficiently combine activation vectors sent by their own child nodes, respectively. This can be achieved by setting hyper-parameters of the neural networks (e.g., the dimensionality of activation vectors), or by performing initial calibration before starting the training.

For training the neural networks in the semantic communications network, suitable training samples are loaded to respective edge devices. For instance, the training samples may comprise images, videos, and audio signals that correspond to various application scenarios. For instance, if a global goal relates to public safety, then images/videos of humans (e.g. criminals, etc.) and weapons may be provided as training samples. If a global goal relates to traffic control, then images/videos of cars, and plates numbers may be provided as training samples.

Further, proper training labels are provided to each node in the network. The training labels at each node may help to train respective SE components to extract relevant semantic facts from input data.

Then, the distributed joint training using a multi-task loss function can be started. The loss function is a measure that describes how close the outputs of a neural network are to the true values. The goal of the training is to minimize the value of the loss function. Usually, a neural network is designed to solve just one particular task, thus a single-task loss function is typically desired. In this disclosure, each neural network can be adapted to perform multiple tasks (e.g., object detection, object recognition, scene-graph generation, etc). Thus, a multi-task loss function that takes multiple tasks into consideration is used for training the respective neural network in this disclosure.

In a forward pass, edge devices pass their input data through their neural networks. The activation values output by respective SE components are used to compute a value of the local loss function, and the activation values output by respective NN-based processing components are forwarded to a parent node.

An intermediate node as a parent node combines received activation values using a predefined technique (e.g., concatenation, stitching, summation, etc.). The combined activation values are duplicated and then passed through the neural networks at the intermediate node. Similarly as before, the activation values output by an SE component are used to compute a local loss, and the activation values output by the NN-based processing component are sent to the following parent node in the next level. The procedure is continued until the FC is reached.

The backward pass generally reverses the operations done in the forward pass. At each intermediate node, the error vectors at the input of an SE component and an NN-based processing component are merged (e.g., added). Then, the merged error vector is split by reversing the “combine” operation done in the forward pass. The obtained split vectors are then distributed to a respective child node. The procedure is continued until each edge device processes the error vectors and updates weights of their respective neural networks.

The forward and backward passes are repeated until convergence of all neural networks.

It is noted that the distributed joint training of FIG. 7 is not an essential but an optional feature/step in this disclosure. It is not necessary to perform the distributed joint training, e.g. when the neural network models of the devices (the parent device and the child device) are already trained.

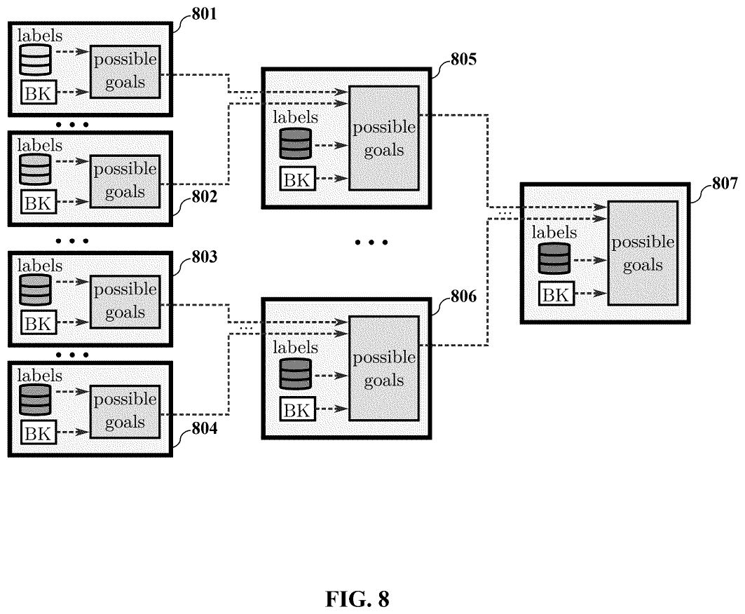

FIG. 8 shows a method for building a set of potential goals that each node is able to solve according to this disclosure. Similar to FIGS. 2, 3, 4, 6, and 7, FIG. 8 shows a system comprising an FC 807, several intermediate nodes 805, 806, and several edge nodes 801-804.

One character of the present solution is a progressive assignment of local goals (or sub-goals) to each node in the network, so that all nodes can contribute to solving a global goal. It would be beneficial for each parent node to be aware of what kind of queries could be answered by their child nodes.

One possible solution is to manually pre-encode the set of potential (or possible) local goals of each node by an operator. However, this approach may become cumbersome in large networks with hundreds of devices. Thus, a method using training datasets is introduced in order to progressively build and propagate the set of possible goals from the edge devices to the FC. This method is illustrated in FIG. 8. As a first step, each edge device uses its local training labels and local background knowledge to build a set of possible goals which the edge device is able to validate. The background knowledge can be pre-encoded or learnt from its own input data. The obtained set of possible goals is then communicated to the parent node. The parent node then builds its own set of possible goals and forwards it to the next node. The process is repeated until the FC is reached.

The goal discovery procedure described above provides a solution for assigning goals. During goal assignment, a parent node checks whether its local goal (or any subset of the local goal) matches with any goal in the set of possible goals of a child node. If yes, the parent node assigns a corresponding sub-goal to the child node.

Optionally, a mechanism of implicit learning (e.g., learning from examples) is introduced, in order to enrich the local context or background knowledge of a node. During the inference phase, a processing node that observes many running examples may derive some new facts and relations which do not appear in the training dataset. If the updated background knowledge helps to solve any new goal by the processing node, this information shall be communicated to its parent node and then propagated until the FC is reached.

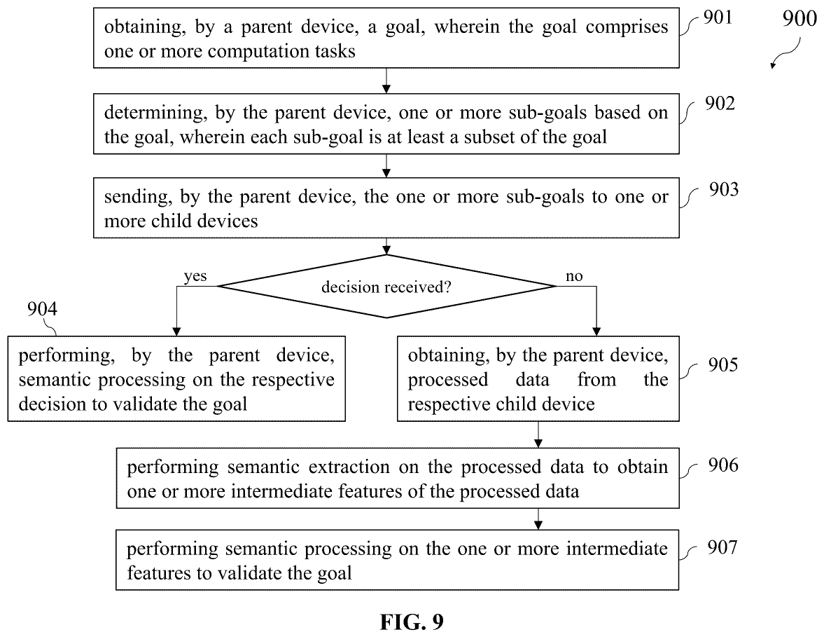

FIG. 9 shows a method 900 according to this disclosure. The method 900 comprises the following steps:
step 901: obtaining, by a parent device, a goal, wherein the goal comprises one or more computation tasks;
step 902: determining, by the parent device, one or more sub-goals based on the goal, wherein each sub-goal is at least a subset of the goal;
step 903: sending, by the parent device, the one or more sub-goals to one or more child devices; and
step 904: responsive to receiving, from a respective child device, a decision of a respective sub-goal: performing, by the parent device, semantic processing on the decision to validate the goal.

Responsive to not receiving, from the respective child device, the decision of the respective sub-goal, the following steps 905-907 are performed:
step 905: obtaining, by the parent device, processed data from the respective child device;
step 906: performing, by the parent device, semantic extraction on the processed data to obtain one or more intermediate features of the processed data; and
step 907: performing, by the parent device, semantic processing on the one or more intermediate features to validate the goal.

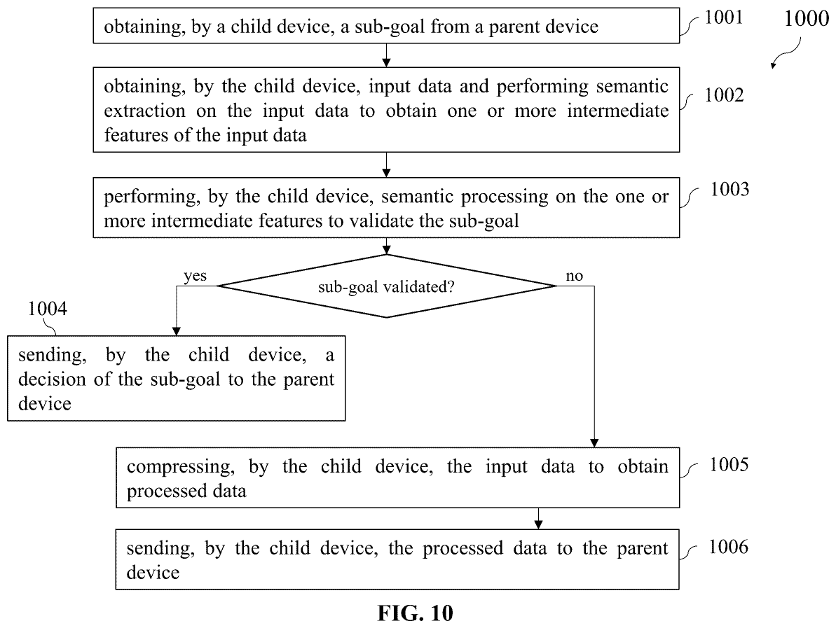

FIG. 10 shows a further method 1000 according to this disclosure. The method 1000 comprises the following steps:
step 1001: obtaining, by a child device, a sub-goal from a parent device;
step 1001: obtaining, by the child device, input data and performing semantic extraction on the input data to obtain one or more intermediate features of the input data;
step 1003: performing, by the child device, semantic processing on the one or more intermediate features to validate the sub-goal; and
step 1004: responsive to determining, by the child device, that the sub-goal is validated: sending, by the child device, a decision of the sub-goal to the parent device.

Responsive to determining, by the child device, that the sub-goal is not validated, the following steps 1005-1006 are performed:
step 1005: compressing, by the child device, the input data to obtain processed data; and
step 1006: sending, by the child device, the processed data to the parent device.

Optionally, before determining whether the sub-goal is validated, the child device may be configured to determine whether there is any valid input. This can be determined based on either one of:
whether there is any valid input obtained for semantic extraction; and
whether there is any intermediate feature extracted.

If there is no valid input or there is no intermediate feature extracted, the child device may be adapted to keep silent (i.e., not to send any decision or processed data). Alternatively, the child device may be adapted to send a synchronized flag to the parent device.

It is noted that the steps of the methods 900, 1000 may share the same functions and details from the perspective of FIGS. 1-8 described above. Therefore, the corresponding method implementations are not described in detail again at this point.

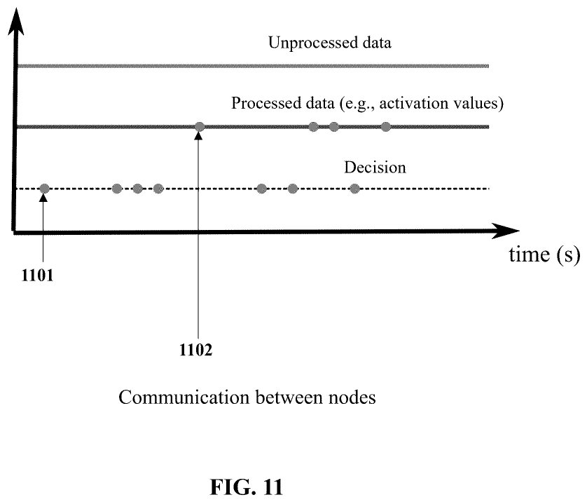

FIG. 11 shows an effect of intermittent communication according to this disclosure.

In a distributed communications network, devices transmit data only when relevant information has been detected. Moreover, either a decision flag or compressed activation values are transmitted. Compared with conventional techniques for distributed inference, the present disclosure can achieve intermittent communication that allows to massively reduce the average communication rate.

An idea of intermittent communication is illustrated in FIG. 11. Consider again a multi-hop topology illustrated as an example in FIG. 4. In a centralized solution, an edge device 401 does not process its input data and instead continuously transmits uncompressed photos/videos to the parent node 405 till the FC 407. In this case, the required bitrate is relatively high. When the edge device uses trained neural networks to compress the video (e.g., frame by frame) and continuously transmits produced activation values to a parent node, the required bitrate can be slightly reduced with respect to the uncompressed data. In the solution according to this disclosure, the edge devices 401 send either decision flags 1101 only when the sub-goal is validated or processed data (e.g., activation values) 1102 only when the sub-goal cannot be (reliably) validated. In this way, the required bitrate can be significantly reduced.

Overall, the present disclosure provides a significantly improved performance (e.g., lower latency, robustness, flexibility, and energy consumption) compared with conventional methods.

The present disclosure may be applied to any type of communications networks. For instance, the present disclosure may be applied to a V2X network where traffic monitoring is required for various purposes (or goals), such as vehicle detection, obstacle detection, speed control, collision detection, etc. For another instance, the present disclosure may be applied to IoT networks, such as Industry 4.0, where various types of sensing nodes are distributed for validating one or more goals.

The device (e.g., the parent device and the child device) in the present disclosure may comprise processing circuitry (not shown) configured to perform, conduct or initiate the various operations of the device described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The processing circuitry comprises one or more processors and a non-transitory memory connected to the one or more processors. The non-transitory memory may carry executable program code which, when executed by the one or more processors, causes the device to perform, conduct or initiate the operations or methods described herein, respectively.

Optionally, the device in the present disclosure may be a single electronic device capable of computing, or may comprise a set of connected electronic devices capable of computing with a shared system memory. It is well-known in the art that such computing capabilities may be incorporated into many different devices, and therefore the term “device” may comprise a PC, server, mobile terminal, tablet, wearable device, graphic processing unit, graphic card, and the like.

The present disclosure has been described in conjunction with various examples as well as implementations. However, other variations can be understood and effected by those persons skilled in the art and practicing the claimed subject matter, from the studies of the drawings, this disclosure, and the independent claims. In the claims as well as in the description the word “comprising” does not exclude other elements or steps and the indefinite article “a” or “an” does not exclude a plurality. A single element or another unit may fulfill the functions of several entities or items recited in the claims. The mere fact that certain measures are recited in the mutual different dependent claims does not indicate that a combination of these measures cannot be used in an advantageous implementation.

What is claimed is:

1. A parent device being configured to:
obtain a goal, wherein the goal comprises one or more computation tasks;
determine one or more sub-goals based on the goal, wherein each sub-goal is at least a subset of the goal;
send the one or more sub-goals to one or more child devices;
responsive to receiving, from a respective child device, a decision of a respective sub-goal, perform semantic processing on the decision to validate the goal; and
responsive to not receiving, from the respective child device, the decision of the respective sub-goal, obtain processed data from the respective child device, perform semantic extraction on the processed data to obtain one or more intermediate features of the processed data, and perform semantic processing on the one or more intermediate features to validate the goal.

2. The parent device according to claim 1, wherein the decision comprises an indication bit indicating the sub-goal is validated.

3. The parent device according to claim 1, wherein the decision comprises a confidence of the decision.

4. The parent device according to claim 1, wherein the decision further comprises one or more extracted features.

5. The parent device according to claim 1, wherein for performing semantic extraction on the processed data, the parent device is configured to detect one or more objects and, optionally, one or more attributes of a detected object from the processed data.

6. The parent device according to claim 1, wherein the parent device comprises a first neural network model adapted to perform semantic extraction.

7. The parent device according to claim 1, wherein for performing semantic processing, the parent device is configured to validate semantic facts that are related to the goal.

8. The parent device according to claim 1, wherein in response to receiving a plurality of decisions from a plurality of child devices, the parent device is configured to combine the plurality of decisions and perform semantic processing on the combined decisions.

9. The parent device according to claim 1, wherein in response to obtaining a plurality of processed data from a plurality of child devices, the parent device is configured to concatenate, sum, or stitch the plurality of processed data.

10. The parent device according to claim 1, wherein in response to determining that the goal is not validated, the parent device is further configured to:
determine the one or more updated sub-goals based on the goal; and
send the one or more updated sub-goals to the one or more child devices.

11. The parent device according to claim 1, wherein the parent device is configured to communicate with the one or more child devices in one or more pre-determined time slots.

12. A child device being configured to:
obtain a sub-goal from a parent device, wherein the sub-goal is at least a subset of a goal of the parent device, wherein the goal comprises one or more computation tasks;
obtain input data and perform semantic extraction on the input data to obtain one or more intermediate features of the input data;
perform semantic processing on the one or more intermediate features to validate the sub-goal;
responsive to determining that the sub-goal is validated, send a decision of the sub-goal to the parent device; and
responsive to determining that the sub-goal is not validated, compress the input data to obtain processed data, and send the processed data to the parent device.

13. The child device according to claim 12, wherein the decision comprises an indication bit indicating the sub-goal is validated.

14. The child device according to claim 12, wherein the decision comprises a confidence of the decision.

15. The child device according to claim 12, wherein for performing semantic extraction on the input data, the child device is configured to detect one or more objects and, optionally, one or more attributes of a detected object from the input data.

16. The child device according to claim 12, wherein the child device comprises a second neural network model adapted to perform semantic extraction.

17. The child device according to claim 12, wherein for performing semantic processing, the child device is configured to validate semantic facts that are related to the sub-goal.

18. The child device according to claim 12, wherein for compressing the input data, the child device comprises a third neural network model adapted to infer the input data, to obtain a feature map of the input data as the processed data.

19. A method comprising:
obtaining, by a parent device, a goal, wherein the goal comprises one or more computation tasks;
determining, by the parent device, one or more sub-goals based on the goal, wherein each sub-goal is at least a subset of the goal;
sending, by the parent device, the one or more sub-goals to one or more child devices;
responsive to receiving, from a respective child device, a decision of a respective sub-goal: performing, by the parent device, semantic processing on the decision to validate the goal; and
responsive to not receiving, from the respective child device, the decision of the respective sub-goal: obtaining processed data from the respective child device; performing semantic extraction on the processed data to obtain one or more intermediate features of the processed data; and performing semantic processing on the one or more intermediate features to validate the goal.

20. A method comprising:
obtaining, by a child device, a sub-goal from a parent device, wherein the sub-goal is at least a subset of a goal of the parent device, wherein the goal comprises one or more computation tasks;
obtaining, by the child device, input data and performing semantic extraction on the input data to obtain one or more intermediate features of the input data;
performing, by the child device, semantic processing on the one or more intermediate features to validate the sub-goal;
responsive to determining that the sub-goal is validated: sending, by the child device, a decision of the sub-goal to the parent device; and
responsive to determining that the sub-goal is not validated: compressing, by the child device, the input data to obtain processed data; and sending, by the child device, the processed data to the parent device.
